(19) United States
(12) Patent Application Publication
(10) Pub. No.: US 2024/0093675 A1
(43) Pub. Date: Mar. 21, 2024

(54) Power Generating Device Using Free Falling of Object Due to Gravity

(71) Applicant: Karamay Xinzhong Petroleum ET Service Co., Ltd., Karamay (CN)

(72) Inventor: Jiacun Feng, Karamay (CN)

(21) Appl. No.: 17/949,631

(22) Filed: Sep. 21, 2022

(51) Int. Cl. F03G 3/00

(52) U.S. Cl. CPC F03G 3/094

(57) ABSTRACT

A power generating device using free falling of object due to gravity is provided, which includes a lifting channel, a falling channel, and mass blocks capable of circularly moving in the lifting channel and the falling channel. Gear structures configured for driving an electric generator to generate power are arranged at a bottom of the falling channel. Racks configured for meshing with the gear structures are arranged on sides of each of the mass blocks, and the mass blocks are capable of driving the gear structures to rotate so as to drive the electric generator to generate power. Mass blocks are lifted up to a top of a falling channel, so as to accumulate gravitational potential energy. A high speed is obtained as the mass blocks fall, and then racks are configured for driving gear structures to rotate so as to drive an electric generator to generate power.

### TECHNICAL FIELD

The present disclosure relates to the fields of energy conversion and utilization technologies, in particular to a power generating device using free falling of object due to gravity.

### BACKGROUND ART

In the prior art, there are multiple utilization modes for renewable energy sources such as wind, light and water, including wind turbine generators, solar cell panels and hydropower stations. The power generation modes have different advantages and disadvantages for effective utilization of the energy sources. Some power generation modes generate pollution to the environment, and some power generation modes consume a large amount of natural resources, as well as some power generation modes are limited by natural conditions and geographic environments. Therefore, the utilization of other available green energy sources has been researched.

For example, the Chinese Patent Application NO. CN204877813U discloses an energy gathering and releasing mechanism. The energy gathering and releasing mechanism includes a first conveying device, a second conveying device, iron balls, a trapezoidal runway for circular movement of the iron balls, and a controller system for controlling the movement of the iron balls. The mechanism can be configured for generating electric energy by accumulating rolling force which is generated by contact between wheels of the vehicle and the road surface in the running process of the vehicle. However, the second conveying device is configured for directly driving the electric generator set. And, only after the iron balls accumulate large potential energy and then release the potential energy, effective energy supply can be obtained.

For another example, the Chinese Patent Application NO. CN201843738U discloses an electricity storage device using heavy object. The electricity storage device includes a double track, an upper wheel-disc rotating shaft, a lower wheel-disc rotating shaft, two closed annular steel ropes, multiple cylindrical heavy objects and multiple traction bolts. The double track is laid along the slope top to the slope bottom of a slope. The upper wheel-disc rotating shaft is arranged at the top of the slope, and the lower wheel-disc rotating shaft is arranged at the bottom of the slope. Wheel discs are respectively fastened at two ends of the upper wheel-disc rotating shaft and the lower wheel-disc rotating shaft. The upper wheel-disc rotating shaft or/and the lower wheel-disc rotating shaft is/are in transmission connection with an electric/power-generation integrated motor in the machine room. The two wheel discs on the same side of the upper wheel-disc rotating shaft and the lower wheel-disc rotating shaft are in transmission connection via each closed annular steel rope. The cylindrical heavy objects are capable of rolling on the double track, and two end faces of each of the cylindrical heavy objects are respectively provided with a protruded short shaft head. Each of the traction bolts is provided with a bearing sleeve and a steel rope clamp. The device enables to store energy in the form of gravitational potential energy of the heavy objects and release the gravitational potential energy during application. However, the electric/power-generation integrated motor is directly driven by the track to rotate, and the driving capacity of the heavy object is limited as well.

### SUMMARY

The present disclosure aims to provide a power generating device using free falling of object due to gravity to solve problems existing in the prior art. Mass blocks are lifted up to a top of a falling channel via the lifting channel, so that the mass blocks accumulate gravitational potential energy. A high speed is obtained as the mass blocks fall, and then racks are configured for driving gear structures to rotate so as to drive an electric generator to generate power. So, the large impact force and the impact speed can be obtained, and thus the electric generator is preferably driven to generate power.

In order to achieve the purpose, the present disclosure provides the following solution.

The present disclosure provides a power generating device using free falling of object due to gravity. The device includes a lifting channel, a falling channel, and mass blocks capable of circularly moving in the lifting channel and the falling channel. Gear structures configured for driving an electric generator to generate power are arranged at a bottom of the falling channel, racks configured for meshing with the gear structures are arranged on sides of each of the mass blocks, and the mass blocks are capable of driving the gear structures to rotate so as to drive the electric generator to generate power.

In some embodiments, the lifting channel includes a driving wheel, a driven wheel and a conveyor belt connected with the driving wheel and the driven wheel.

In some embodiments, the driven wheel may be connected with a ratchet and pawl structure, and the conveyor belt may drive the mass blocks to lift gradually.

In some embodiments, the driving wheel may be connected with a cycloidal-pin wheel speed-change motor.

In some embodiments, the falling channel includes limiting guide rails, and limiting grooves matched with the limiting guide rails may be formed in each of the mass blocks.

In some embodiments, a pressure buffer mechanism may be arranged at a part, below the gear structures, of the falling channel.

In some embodiments, the pressure buffer mechanism may be connected with a piezoelectric electric generator.

In some embodiments, the pressure buffer mechanism may be a hydraulic buffer.

In some embodiments, a storage channel may be further connected between a top of the lifting channel and a top of the falling channel and configured for storing ones of mass blocks, and an inlet end of the storage channel may be higher than an outlet end of the storage channel.

In some embodiments, a conveying channel may be further connected between a bottom of the lifting channel and the bottom of the falling channel, and an inlet end of the conveying channel may be higher than an outlet end of the conveying channel.

Compared with the prior art, the embodiments have the following technical effects.

Firstly, each of the mass blocks can be lifted up to the top of the falling channel via the lifting channel, so that the mass block accumulates gravitational potential energy. A high speed is obtained as the mass block falls, and then the racks are configured for driving the gear structures to rotate so as to drive the electric generator to generate power. So, the large impact force and the impact speed can be obtained, and the electric generator can be preferably driven to generate power.

Secondly, the driven wheel of the lifting channel is connected with a ratchet and pawl structure, and the conveyor belt drives each of the mass blocks to lift up gradually via the ratchet and pawl structure, so that gravitational potential energy of the mass block can be continuously increased by applying intermittent external force, and finally the mass block is lifted up to a set height.

Thirdly, the falling channel includes limiting guide rails. Limiting grooves matched with the limiting guide rails are formed on each of the mass blocks. Therefore, when the mass block falls down, a moving track of the mass block can be restrained, so that it is guaranteed that the mass block can effectively drive the gear structures to operate, and energy loss can be reduced.

Fourthly, the pressure buffer mechanism is arranged at the bottom of the falling channel. The pressure buffer mechanism can reduce the impact influence of the mass blocks and protect the mass blocks. The partial impact energy can be converted into electric energy which can be stored and recycled, or transferred to the driving wheel again, when the piezoelectric electric generator is started, so that the energy loss can be further reduced.

### BRIEF DESCRIPTION OF THE DRAWINGS

To illustrate the technical solutions in the embodiments of the present discourse more clearly, the accompanying drawings will be briefly described below. Apparently, the accompanying drawings in the following descriptions show merely some embodiments of the present disclosure. For those of ordinary skill in the art, other drawings may be obtained according to the accompanying drawings without creative efforts.

FIG. 1 is a schematic diagram of an overall structure of the device according to an embodiment of the present disclosure;

FIG. 2 is a structural schematic diagram of a mass block according to an embodiment of the present disclosure;

FIG. 3 is a schematic diagram of a meshed structure of a rack and a gear structure according to an embodiment of the present disclosure;

FIG. 4 is a structural schematic diagram of a hydraulic buffer according to an embodiment of the present disclosure; and

FIG. 5 is a structural schematic diagram of a cross section of a falling channel according to an embodiment of the present disclosure.

Reference signs: 1 lifting channel; 11 driven wheel; 12 driving wheel; 121 cycloidal-pin wheel speed-change motor; 13 conveyor belt; 2 falling channel; 21 limiting guide rail; 3 mass block; 31 rack; 32 limiting groove; 4 storage channel; 5 conveying channel; 6 electric generator; 71 gear structure; 72 speed change gear; 73 brake wheel; 8 control system; 9 hydraulic buffer; 91 balancing weight; 92 piston; 93 hydraulic tank; 94 supporting plate; 95 adjusting valve; 96 sliding rail; 97 horizontal weight; 98, balance plate; and 99 liquid inlet and outlet.

### DETAILED DESCRIPTION OF THE EMBODIMENTS

Technical solutions in the embodiments of the present disclosure will be clearly an d completely described herein below with reference to the accompanying drawings in the embodiments of the present disclosure. Apparently, the described embodiments are merely a part rather than all of the embodiments of the present disclosure. Based on the embodiment of the present disclosure, all other embodiments obtained by those of ordinary skill in the art under the premise of without contributing creative labor shall fall within the scope protected by the present disclosure.

The present disclosure aims to provide a power generating device using free falling of object due to gravity to solve problems existing in the prior art. Each of the mass blocks can be lifted up to the top of the falling channel via the lifting channel, so that the mass blocks accumulate gravitational potential energy. A high speed is obtained as the mass blocks falls, and then the racks are configured for driving the gear structures to rotate so as to drive the electric generator to generate power. Large impact force and the impact speed can be obtained, and the electric generator can be preferably driven to generate power.

To make the foregoing objective, features and advantages of the present disclosure clearer and more comprehensible, the present disclosure is further described in detail below with reference to the accompanying drawings and specific embodiments.

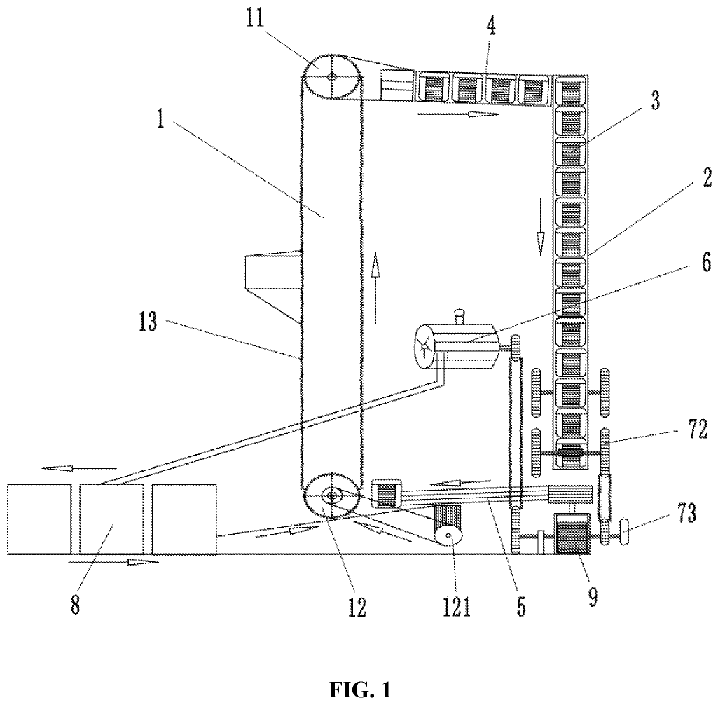

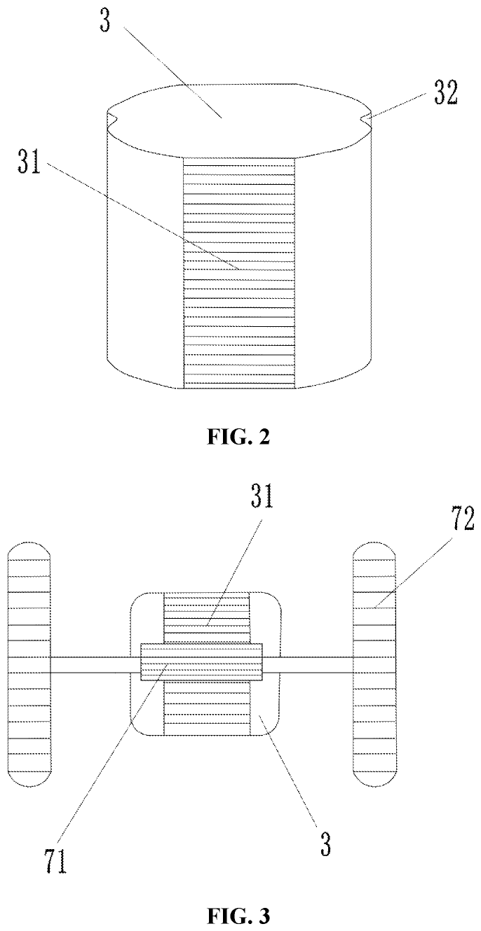

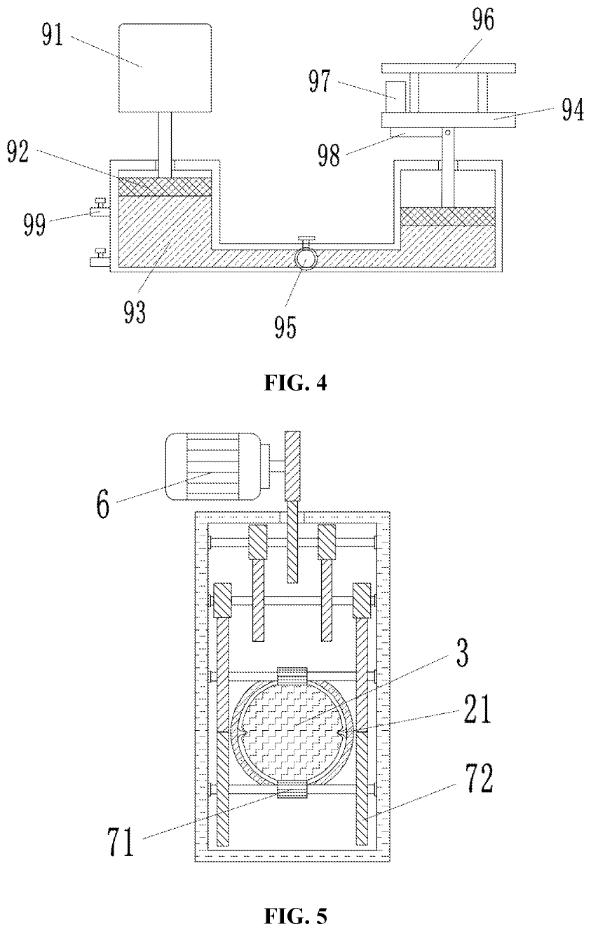

As shown in FIGS. 1 to 5, the present disclosure provides a power generating device using free falling of object due to gravity. The technology includes a lifting channel 1, a falling channel 2, and mass blocks 3 capable of circularly moving in the lifting channel 1 and the falling channel 2. The energy source of the lifting channel 1 can be an available external energy source which includes electric energy. The purpose is to lift up each of the mass blocks 3 to the top of the falling channel 2, and then the mass block 3 is released, so that the mass block 3 can fall down in the falling channel 2 from top to bottom. Gear structures 71 configured for driving the electric generator 6 to generate power are arranged at the bottom of the falling channel 2. Racks 31 configured for being meshed with the gear structures 71 are arranged on sides of the mass block 3. The gear structures 71 can be symmetrically arranged on the two sides of the mass block 3 and meshed with the racks 31 arranged on the two sides respectively. When the mass block 3 reaches the position where the gear structures 71 is located, the mass block 3 has a certain speed and a certain impact force, and therefore the mass block 3 can drive the gear structures 71 to rotate so as to drive the electric generator 6 to generate power. The gear structures 71 may also be connected to speed change gears 72. Each of the speed change gears 72 may include multi-stage speed change gears, so that the electric generator 6 obtains a higher rotational speed. The speed change gear 72 may also be connected to a brake wheel 73 for controlling the rotational speed or operating state of the electric generator 6. A higher speed is obtained as the mass block 3 falls down, and then the racks 31 drive the gear structures 71 to rotate so as to drive the electric generator 6 to generate power. So, the large impact force and the impact speed can be obtained, the electric generator 6 can be preferably driven to generate power, and high power can be obtained by using small energy.

The lifting tunnel 1 may include a driving wheel 12, a driven wheel 11 and a conveyor belt 13 connected with the driving wheel 12 and the driven wheel 11. Under the driving of the driving wheel 12, the conveyor belt 13 can lift up the mass block 3 continuously until the mass block 3 reaches the position above the falling channel 2. And a bearing plate, a hook or other structures for carrying the mass block 3 to move can be arranged on the conveyor belt 13. The energy source for the driving wheel 12 can be any external conventional energy that can be converted into rotational forms, such as human power, stored power and wind power.

The driven wheel 11 can be connected with a ratchet and pawl structure, the conveyor belt 13 can drive the mass block 3 to be gradually lifted up via the ratchet and pawl structure, gravitational potential energy of the mass block 3 can be continuously increased by applying intermittent external force, and finally the mass block 3 is lifted up to the set height.

The driving wheel 12 can be connected with a cycloidal-pin wheel speed-change motor 121 which is called by a control system 8, so that energy can be reasonably distributed.

The falling channel 2 includes limiting guide rails 21. Each of the limiting guide rails 21 is arranged in the vertical direction and provided with lubricating structures such as lubricating oil. Limiting grooves 32 matched with the limiting guide rails 21 are formed in the mass block 3. When the mass block 3 falls down, the limiting guide rails 21 can be configured for restraining the moving track of the mass block 3, so that it is guaranteed that the mass block 3 can effectively drive the gear structures 71 to operate, and energy loss is reduced.

A pressure buffer mechanism can be further arranged at a part, below the gear structures 71, of the falling channel 2. The pressure buffer mechanism can reduce the impact influence of the mass block 3. Meanwhile, the effect of protecting the mass block 3 is achieved, thereby preventing the service life of the mass block from being reduced due to repeated impact.

The pressure buffer mechanism can be connected with a piezoelectric electric generator which can convert a part of the impact energy into electric energy. The part of the electric energy can be stored and recycled, or transferred to the driving wheel 12 again, so that the energy loss is further reduced.

The pressure buffer mechanism can be a hydraulic buffer 9 which includes two hydraulic tanks 93 communicating with each other. The two hydraulic tanks 93 communicate with each other via an adjusting valve 95 which can control the size of the flow rate of liquid between the two hydraulic tanks 93. Further, the size of the reduced pressure of the mass block 3 can be adjusted, and the mass block 3 can be protected. A liquid inlet and outlet 99 is formed in the side wall of one of the two hydraulic tanks 93, which includes a liquid inlet and a liquid outlet for filling oil into or discharging oil from the hydraulic tank 93. A piston 92 is arranged in each of the two hydraulic tanks 93. One piston 92 is connected with a balancing weight 91, and the other piston 92 is connected with a supporting plate 94. When the supporting plate 94 is impacted by the mass block 3, the piston 92 connected with the supporting plate 94 is pressed to move downwards in the same direction. At the moment, the piston 92 connected with the balancing weight 91 moves upwards, and then descending buffering of the mass block 3 is achieved. After the impact is finished, the balancing weight 91 presses the piston 92 connected with the balancing weight 91, the piston 92 connected with the supporting plate 94 moves up, and then the supporting plate 94 moves upwards and back to the balanced position. The supporting plate 94 is hinged and connected to the vertical rod of the piston 92, the mass block 3 enables the supporting plate 94 to rotate by the weight of the mass block 3, so that the mass block 3 leaves the supporting plate 94 and slides onto the conveyor channel 5. The side, away from the lifting channel 1, of the supporting plate 94 is provided with a balance plate 98. The upper surface of the supporting plate 94 is connected with a sliding rail 96 via a supporting rod. The sliding rail 96 facilitates sliding movement of the mass block 3. The bottom end of the mass block 3 can be provided with a tapered roller bearing set matched with the sliding rail 96. The tapered roller bearing set includes a universal wheel and two fixed wheels, and can conveniently slide on the sliding rail 96. A horizontal weight 97 is further arranged on the same side as the balance plate 98, which can drive the sliding rail 96 and the supporting plate 94 of the sliding rail 96 to reset after the mass block 3 slides out due to the sliding rail 96 inclines towards one side of the lifting channel 1. So, the newly-falling mass block 3 is borne by the sliding rail 96, and the working continuity of the hydraulic buffer 9 is guaranteed.

A storage channel 4 is further connected between the top of the lifting channel 1 and the top of the falling channel 2. The storage channel 4 has a certain length and can be configured for storing multiple mass blocks 3. That is, whether or not the mass blocks 3 fall down or how many mass blocks 3 fall down can be controlled according to requirements of energy conversion or electric power. The inlet end of the storage channel 4 is higher than the outlet end of the storage channel 4. The mass blocks 3 can freely slide to the outlet end, namely above the falling channel 2, on the storage channel 4 under the action of their own gravity.

A conveying channel 5 is further connected between the bottom of the lifting channel 1 and the bottom of the falling channel 2 and configured for conveying the recovered mass blocks 3 falling in the falling channel 2 to the position below the lifting channel 1. The inlet end of the conveying channel 5 is higher than the outlet end of the conveying channel 5. The mass blocks 3 can freely slide to the outlet end, namely below the lifting channel 1, on the conveying channel 5 under the action of their own gravity.

The working process is as follows.

For each of the mass blocks 3, during operation, the mass block 3 on the storage channel 4 slides to the position above the falling channel 2 under the action of gravity. After a limiting structure of the mass block 3 is removed, the mass block 3 can enter the falling channel 2. The limiting grooves 32 formed on the mass block 3 are matched with the limiting guide rails 21 arranged on the falling channel 2, so that it can be guaranteed that the mass block 3 falls according to a set path. When the mass block 3 reaches the gear structures 71, the racks 31 arranged on the mass block 3 is meshed with the gear structures 71, and then the gear structures 71 are driven by the racks 31 to rotate rapidly. The gear structures 71 transmit the rotational speed via the speed change gears 72 connected with the gear structures 7. The speed change gears 72 may include a first-stage speed change gear, a second-stage speed change gear, a third-stage speed change gear, a fourth-stage speed change gear, and the like. After the multi-stage speed change, a driving shaft of the electric generator 6 can rotate to a certain speed, and then the electric generator 6 can be driven to generate power. When the mass block 3 descends to the bottom of the falling channel 2, the mass block 3 can fall onto the sliding rail 96 of the hydraulic buffer 9. Under the action of gravity and impact force of the mass block 3, the piston 92 on the same side is driven to descend. The piston 92 compresses hydraulic oil in the hydraulic tank 93 close to the lifting channel 1 to enable the piston 92 in the hydraulic tank 93 away from the lifting channel 1 to ascend. Pressure buffering is generated when the mass block 3 descends, so that damages and injuries are avoided. And then, the mass block 3 slides into the bottom end of the lifting channel 1 via the conveying channel 5 and attached to the conveyor belt 13 by means of a structure such as a hook or tray. The driving wheel 12 rotates to drive the conveyor belt 13 to lift upwards, and then the mass block 3 is driven to lift upwards. Due to the fact that the driven wheel 11 is provided with the ratchet and pawl structure, the conveyor belt 13 can be intermittently lifted upwards. And then the mass blocks 3 can be lifted to the position above the lifting channel 1 and enter the storage channel 4. Due to the fact that the storage channel 4 has a certain length and storage capacity, multiple mass blocks 3 can be stored in the storage channel 4. The mass block 3 in the storage channel 4 can enter the falling channel 2 again, so that the circular movement of the mass blocks 3 is realized. The whole device operates and generates power according to requirements.

Specific examples are used in this specification for illustration of the principles and implementation methods of the present disclosure. The description of the above-mentioned embodiments is merely used to help understand the method and core concept of the present disclosure. In addition, those of ordinary skill in the art can make various modifications to specific implementations and application scope in accordance with the concept of the present disclosure. In conclusion, the content of this specification shall not be construed as a limitation to the present disclosure.

1. A power generating device using free falling of object due to gravity, comprising a lifting channel, a falling channel, and mass blocks capable of circularly moving in the lifting channel and the falling channel, wherein gear structures configured for driving an electric generator to generate power are arranged at a bottom of the falling channel, racks configured for meshing with the gear structures are arranged on sides of each of the mass blocks, and the mass blocks are capable of driving the gear structures to rotate so as to drive the electric generator to generate power,
wherein a storage channel is further connected between a top of the lifting channel and a top of the falling channel and configured for storing ones of the mass blocks, and an inlet end of the storage channel is higher than an outlet end of the storage channel.

2. The power generating device using free falling of object due to gravity according to claim 1, wherein the lifting channel comprises a driving wheel, a driven wheel and a conveyor belt connected with the driving wheel and the driven wheel.

3. The power generating device using free falling of object due to gravity according to claim 2, wherein the driven wheel is connected with a ratchet and pawl structure, and the conveyor belt drives the mass blocks to lift up gradually.

4. The power generating device using free falling of object due to gravity according to claim 3, wherein the driving wheel is connected with a cycloidal-pin wheel speed-change motor.

5. The power generating device using free falling of object due to gravity according to claim 1, wherein the falling channel comprises limiting guide rails, and limiting grooves matched with the limiting guide rails are formed on each of the mass blocks.

6. The power generating device using free falling of object due to gravity according to claim 1, wherein a pressure buffer mechanism is arranged at a part, below the gear structures, of the falling channel, and the pressure buffer mechanism is a hydraulic buffer which includes two hydraulic tanks communicating with each other via an adjusting valve, and a piston arranged in each hydraulic tank, wherein one piston is connected with a balancing weight, and the other piston is connected with a supporting plate for receiving the mass blocks.

7. The power generating device using free falling of object due to gravity according to claim 6, wherein the pressure buffer mechanism is connected with a piezoelectric electric generator.

8. The power generating device using free falling of object due to gravity according to claim 6, wherein the pressure buffer mechanism is a hydraulic buffer.

9. (canceled)

10. The power generating device using free falling of object due to gravity according to claim 1, wherein a conveying channel is further connected between a bottom of the lifting channel and the bottom of the falling channel, and an inlet end of the conveying channel is higher than an outlet end of the conveying channel.
